(19) United States
(12) Patent Application Publication
(10) Pub. No.: US 2012/0188390 A1
(43) Pub. Date: Jul. 26, 2012

(54) Methods And Apparatuses For Out-Of-Gamut Pixel Color Correction

(75) Inventors: Ro'ee Sfaradi, Nes Ziona (IL); Eugene Fainstain, Netanya (IL); Artem Zinevich, Tel Aviv-Yafo (IL)

(73) Assignee: SAMSUNG ELECTRONICS CO., LTD., Suwon-si (KR)

(21) Appl. No.: 13/014,144

(22) Filed: Jan. 26, 2011

(51) Int. Cl. G09G 5/02; H04N 5/225

(52) U.S. Cl. 348/222.1; 345/590; 348/E05.024

(57) ABSTRACT

In a method for out-of-gamut color correction of images, the image is color corrected by compressing pixel vectors having a maximal component located outside of the output color gamut to within the output color gamut while retaining a hue of the image. An electronic imaging system includes an image signal processor configured to color correct the image for display by the output device by compressing pixel vectors having a maximal component located outside of the output color gamut to within the output color gamut while retaining a hue of the image.

### BACKGROUND

Image sensors in digital still cameras (DSCs) and the like produce a mesh of pixels. The color of each pixel can be represented by a vector known as a tristimulus vector. The tristimulus vector is comprised of three elements or coordinates, which define a point in a given color space. The mapping between the tristimulus vector and a particular color is related to the physical properties of the input (or source) device (e.g., a DSC).

Conventionally, color correction is performed to map the tristimulus vector of a pixel of the input device to a tristimulus vector that describes the same color using the primaries (light sources, such as red, green and blue (RGB)) of a target or output device. Color correction may be performed by an image signal processor (ISP) within the input or output device. Example output devices include display devices such as a cathode-ray tube (CRT) displays, liquid crystal displays (LCDs), plasma displays, organic light emitting diode (OLED) displays, etc.

In one example, conventional color correction is performed by applying a single linear transformation on the entire input color space of the input device. More advanced methods of color correction partition the color space into sectors and apply a linear transformation on each sector.

When applying color correction to the input color space, some of the output colors will be out of range of the output gamut, which refers to the range of colors capable of display by the output device. Gamut mapping is performed to enable display of colors outside the bounds of the output gamut. There are several conventional approaches to gamut mapping.

In one example, linear color correction transformation is performed, and then all values outside of the output gamut are clipped. However, this approach creates distortion in the hue of the colors. In addition, there is information loss because a range of tristimulus vectors that are outside the output gamut are mapped to a single tristimulus vector on the boundary of the output gamut.

### SUMMARY

Example embodiments provide methods and apparatuses for gamut compression, which preserves the original hue of color while distorting luminance and/or saturation.

According to at least some example embodiments, white balance (WB) and/or gray balance is assumed to be performed prior to color correction. Example embodiments are compatible with, for example, standard linear color correction, which preserves gray colors, hue-partitioned linear color correction, etc.

At least some example embodiments allow color correction with control as to how to represent colors that are outside of the output gamut, but without distorting the hue of the original color. Example embodiments do not require an implementation of three dimensional look up table (LUT) and are relatively hardware efficient.

Gamut mapping methods according to at least some example embodiments may be used together with linear or linear-like color correction methods in order to handle colors that fall outside the output gamut.

At least one example embodiment provides a method for out-of-gamut color correction of an image for display by an output device having a corresponding output color gamut. The image includes a plurality of pixels and each of the plurality of pixels has a corresponding pixel vector. According to at least this example embodiment, the image is color corrected by compressing pixel vectors having a maximal component located outside of the output color gamut to within the output color gamut while retaining a hue of the image.

According to at least some example embodiments, at least a first maximal component of at least a first of the pixel vectors is compared with a gamut threshold value, and the first pixel vector is compressed if the first maximal component exceeds the gamut threshold value. The first pixel vector is not compressed if the first maximal component does not exceed the gamut threshold value. The input pixel vectors may and/or should be white balanced prior to the color correcting.

According to at least some example embodiments, the first pixel vector corresponds to a first pixel among the plurality of pixels.

According to one or more example embodiments, a target luminance for the first pixel is calculated based on a weighted luminance metric for the first pixel and the gamut threshold value. The first pixel vector is then compressed at least partially based on the calculated target luminance. The target luminance is equal to a minimum value from among the weighted luminance metric and the gamut threshold value.

According to one or more other example embodiments, a target luminance for the first pixel is calculated based on a weighting constant, a luminance of the first pixel and the gamut threshold value. The first pixel vector is then compressed based on the calculated target luminance.

According to one or more other example embodiments, the target luminance for the first pixel is set equal to zero, and the first pixel vector is compressed based on the set target luminance.

According to at least some example embodiments, an input saturation pixel vector associated with the first pixel is calculated. At least one component of the input saturation pixel vector represents a maximum value for a color in an input color space, which is a color space associated with an image acquisition device having acquired the image. An output saturation pixel vector is then calculated by applying a color correction matrix to the input saturation pixel vector. The first pixel vector is compressed based on the target luminance and the output saturation pixel vector.

According to at least some example embodiments, the pixel vectors are compressed by applying a compression factor to the pixel vectors. In one example, the pixel vectors are compressed by: shifting tristimulus vectors associated with the first pixel such that a target luminance for the first pixel is located at an origin of an output color space; calculating a compression factor based on the shifted tristimulus vectors; and compressing the pixel vectors based on the compression factor, the shifted input pixel vector and the target luminance. According to at least this example embodiment, the tristimulus vectors include at least an input pixel vector representing a color of the first pixel.

According to at least some example embodiments, the pixel vectors are generated by applying color correction (e.g., linear or piece-wise linear color correction) to a plurality of input pixel vectors. Each of the plurality of input pixel vectors represents a color of a corresponding one of the plurality of pixels.

At least one other example embodiment provides an electronic imaging system configured to perform out-of-gamut color correction of an image for display by an output device having a corresponding output color gamut. The image includes a plurality of pixels and each of the plurality of pixels has a corresponding pixel vector. According to at least this example embodiment, the electronic imaging system includes: an image signal processor configured to color correct an image for display by the output device by compressing pixel vectors having a maximal component located outside of the output color gamut to within the output color gamut while retaining a hue of the image.

According to at least some example embodiments, the electronic imaging system further includes: an image sensor configured to acquire the image by converting incident light into a digital output code; a display device configured to display the color corrected image; and/or a memory configured to store the color corrected image.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected example embodiments and not all possible implementations, and are not intended to limit the scope of the present disclosure.

FIG. 1A illustrates an example architecture of a conventional image sensor.

FIG. 1B illustrates an imaging system according to an example embodiment.

FIG. 2 illustrates an example of an image signal processor included in the imaging system of FIG. 1B according to an example embodiment.

FIGS. 3A through 3C illustrate example color correction transformation effects for a pixel according to an example embodiment.

FIG. 4 is a flow chart illustrating a method for color correction according to an example embodiment.

FIG. 5 is a flow chart illustrating an example embodiment of S412 shown in FIG. 4.

FIGS. 6A and 6B are graphs for illustrating a method for mapping a tristimulus vector to its compressed value according to an example embodiment.

FIG. 7 is a graph illustrating an example input/output scheme for a pixel.

FIG. 8 is a graph for illustrating a method for calculating a compression curve according to an example embodiment.

Corresponding reference numerals indicate corresponding parts throughout the several views of the drawings.

### DETAILED DESCRIPTION

Detailed example embodiments are disclosed herein. However, specific structural and functional details disclosed herein are merely representative for purposes of describing example embodiments. Example embodiments may be embodied in many alternate forms and should not be construed as limited to only the embodiments set forth herein. Moreover, example embodiments are to cover all modifications, equivalents, and alternatives falling within the scope of this disclosure. Like numbers refer to like elements throughout the description of the figures.

Although the terms first, second, etc. may be used herein to describe various elements, these elements should not be limited by these terms. The terms are only used to distinguish one element from another. For example, a first element could be termed a second element, and similarly, a second element could be termed a first element, without departing from the scope of this disclosure. As used herein, the term “and/or” includes any and all combinations of one or more of the associated listed items.

When an element is referred to as being “connected” or “coupled” to another element, it may be directly connected or coupled to the other element or intervening elements may be present. By contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

In some alternative implementations, the functions/acts noted may occur out of the order noted in the figures. For example, two figures shown in succession may in fact be executed substantially concurrently or simultaneously or may sometimes be executed in the reverse order, depending upon the functionality/acts involved.

In some cases, portions of example embodiments and corresponding detailed description are described in terms of software or algorithms and symbolic representations of operations performed by, for example, an image signal processor (ISP). These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the following description, at least some example embodiments will be described with reference to acts and symbolic representations of operations (e.g., in the form of flowcharts) that may be implemented as program modules or functional processes including routines, programs, objects, components, data structures, etc., which perform particular tasks or implement particular abstract data types and may be implemented in hardware such as ISPs in digital still cameras (DSCs) or the like.

Unless specifically stated otherwise, or as is apparent from the discussion, terms such as “processing,” “computing,” “calculating,” “determining,” “displaying” or the like, refer to the action and processes of a computer system, ISP or similar electronic computing device, which manipulates and transforms data represented as physical, electronic quantities within registers and/or memories into other data similarly represented as physical quantities within the memories, registers or other such information storage r display devices.

Note also that software implemented aspects of example embodiments are typically encoded on some form of computer readable storage medium. The computer readable storage medium may be magnetic (e.g., a floppy disk or a hard drive) or optical (e.g., a compact disk read only memory, or “CD ROM”), and may be read only or random access. Example embodiments are not limited by these aspects of any given implementation.

Example embodiments of methods for color correction will be discussed in more detail below. As an example, methods for color correction will be described with reference to a color correction matrix (CCM) unit of an ISP.

Although example embodiments are discussed herein as “units,” these components may also be referred to as “circuits” or the like. For example, the CCM unit may be referred to as a CCM circuit.

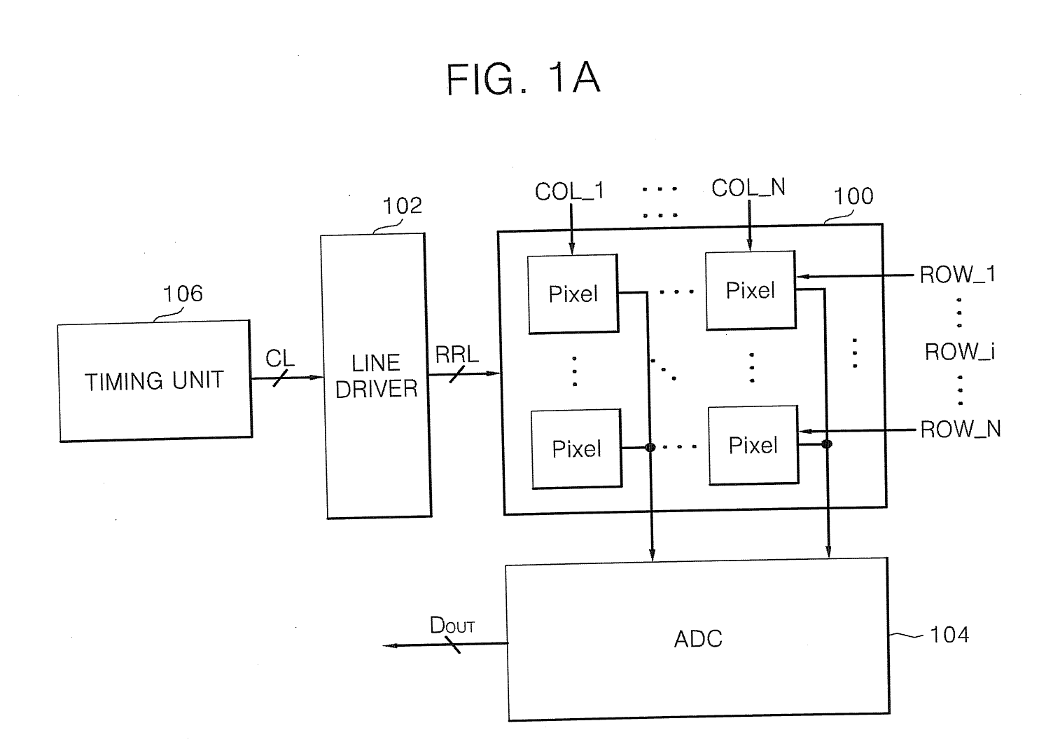

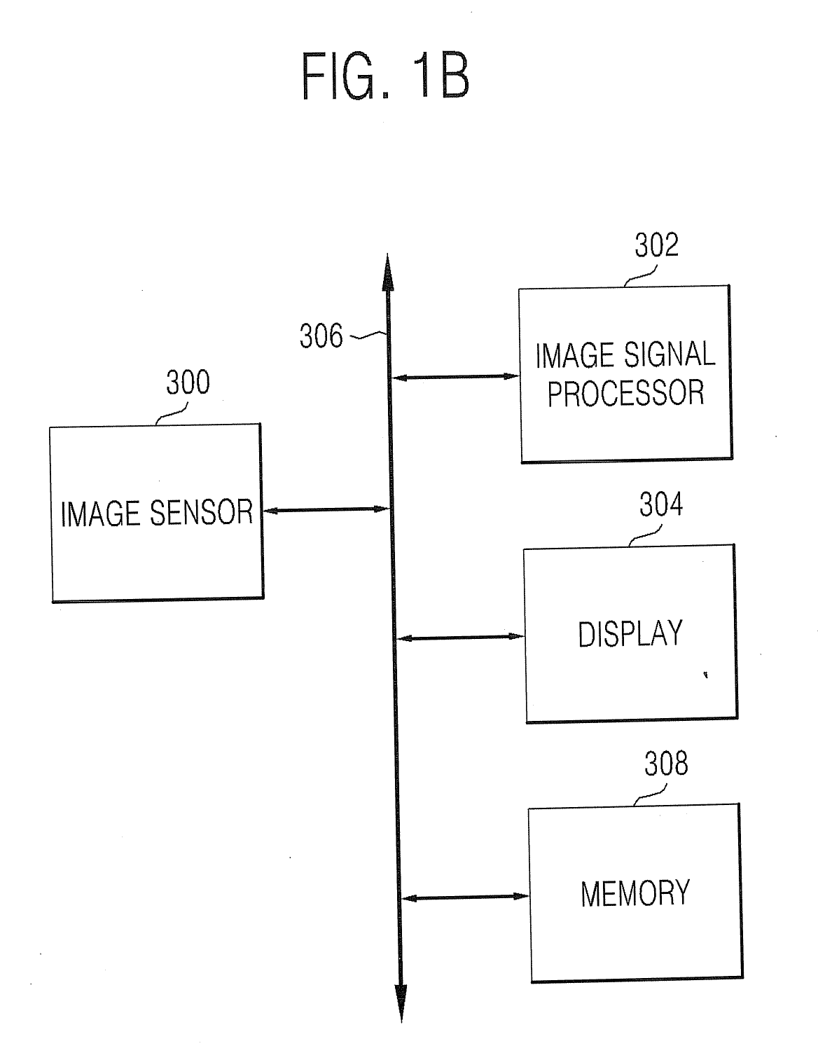

FIG. 1A illustrates an example architecture of a conventional complementary-metal-oxide-semiconductor (CMOS) image sensor. The image sensor illustrated in FIG. 1A may be used in, for example, a digital still camera (DSC). Though example embodiments of color correction and/or compression methods are described with reference to the CMOS image sensor illustrated in FIG. 1A, it will be understood that example embodiments described herein may be used with (or in conjunction with) any device that performs gamut mapping or transformation of a linear color space. For example, in addition to DSCs, methods described herein may also be used with copiers, scanners, printers, televisions, computer monitors, projectors, etc. The CMOS image sensor illustrated in FIG. 1A will now be discussed in greater detail.

Referring to FIG. 1A, a timing unit 106 controls a line driver 102 through one or more control lines CL. In one example, the timing unit 106 causes the line driver 102 to generate a plurality of read and reset pulses. The line driver 102 outputs the plurality of read and reset pulses to a pixel array 100 on a plurality of select lines RRL.

The pixel array 100 includes a plurality of pixels P arranged in an array of rows ROW_1 through ROW_N and columns COL_1 through COL_N. Each of the plurality of select lines RRL corresponds to a row of pixels in the pixel array 100. In FIG. 1A, each pixel may be an active-pixel sensor (APS), and the pixel array 100 may be an APS array. Each pixel is capable of receiving light and generating an electrical signal based on the received light.

In more detail with reference to example operation of the image sensor in FIG. 1A, read and reset pulses for an i^{th} row ROW_i (where i={1, . . . , N}) of the pixel array 100 are output from the line driver 102 to the pixel array 100 via an i^{th} one of the select lines RRL. In one example, the line driver 102 applies a reset signal to the i^{th} row ROW_i of the pixel array 100 to begin an exposure period. After a given, desired or predetermined exposure time, the line driver 102 applies a read signal to the same i^{th} row ROW_i of the pixel array to end the exposure period. The application of the read signal also initiates reading out of pixel information (e.g., exposure data) from the pixels P in the i^{th} row ROW_i.

The pixel array 110 may also include a color filter array (CFA) following, for example, a Bayer pattern.

The analog to digital converter (ADC) 104 converts the output voltages from the i^{th} row of readout pixels into a digital signal (or digital code) D_{OUT}. The ADC 104 outputs the digital signal D_{OUT} to an image signal processor (not shown in FIG. 1A). The ADC 104 may perform this conversion either serially or in parallel. For example, if the ADC 104 has a column parallel-architecture, the ADC 104 converts the output voltages into the digital signal Dour in parallel.

FIG. 1B is a block diagram illustrating an electronic imaging system according to an example embodiment.

Referring to FIG. 1B, the electronic imaging system includes, for example: an image sensor 300, an image signal processor (ISP) 302, a display 304 and a memory 308. The image sensor 300, the ISP 302, the display 304 and the memory 308 communicate with each other via a bus 306.

The image sensor 300 may be an image sensor as described above with regard to FIG. 1A. The image sensor 300 is configured to capture image data by converting optical images into electrical signals. The electrical signals are output to the ISP 302.

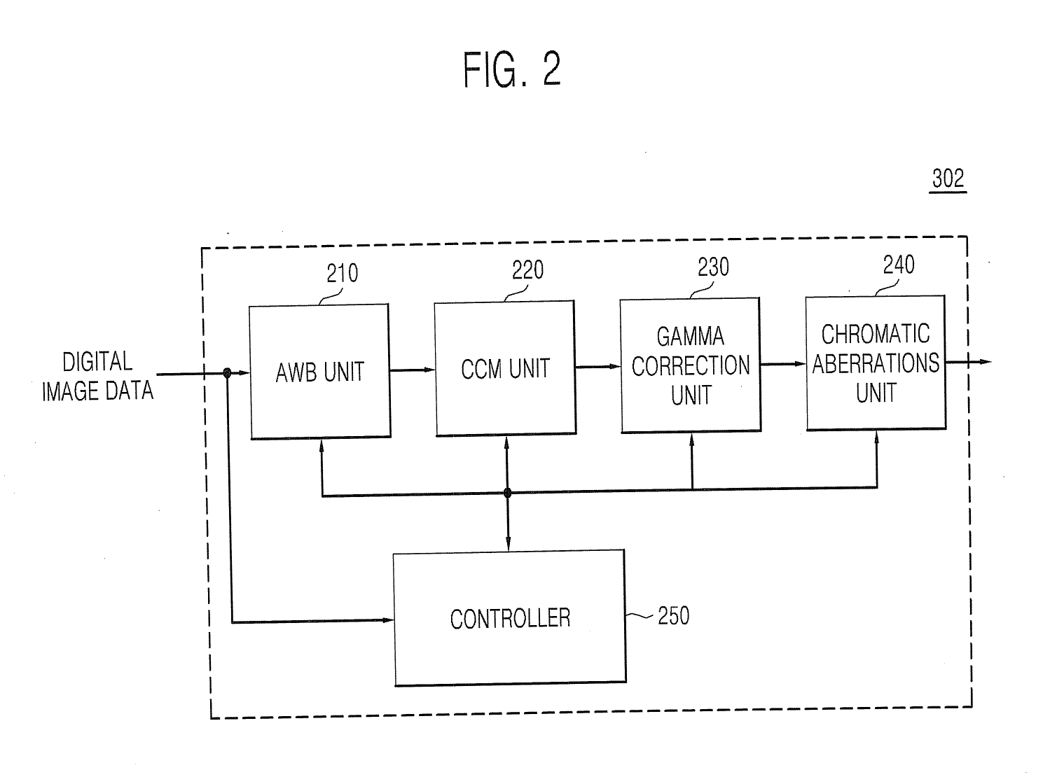

The ISP 302 processes the captured image data for storage in the memory 308 and/or display by the display 304. In more detail, the ISP 302 is configured to: receive digital image data from the image sensor 300; perform image processing operations on the digital image data; and output a processed image. An example embodiment of the ISP 302 will be discussed in greater detail below with regard to FIG. 2.

The ISP 302 is also configured to execute a program and control the electronic imaging system. The program code to be executed by the ISP 302 may be stored in the memory 308. The memory 308 may also store digital image data acquired by the image sensor and processed by the ISP 302. The memory 308 may be any suitable volatile or non-volatile memory.

The electronic imaging system shown in FIG. 1B may be connected to an external device (e.g., a personal computer or a network) through an input/output device (not shown) and may exchange data with the external device.

The electronic imaging system shown in FIG. 1B may embody various electronic control systems including an image sensor, such as a DSC. Moreover, the electronic imaging system may be used in, for example, mobile phones, personal digital assistants (PDAs), laptop computers, netbooks, MP3 players, navigation devices, household appliances, or any other device utilizing an image sensor or similar device.

FIG. 2 illustrates an example embodiment of the ISP 302 shown in FIG. 1B in greater detail.

Referring to FIG. 2, at the ISP 302, an auto white balancing (AWB) unit 210 applies white balancing functions to the received digital image data from the image sensor 300 and outputs the white balanced image data to a color correction matrix (CCM) unit 220.

The CCM unit 220 performs color correction on the white balanced digital image data and outputs color corrected digital image data to a gamma correction unit 230. In one example, during or after color correction, the CCM unit 220 compresses pixel values outside of a color gamut of an output device to within the output color gamut while preserving a hue of the acquired image. The color correction applied by the CCM unit 220 may be linear in the entire gamut space or piece-wise linear in sub-spaces of the gamut space. For example, the color correction may be linear in two-dimensional sub-spaces including the main diagonal of the gamut and the pixel being corrected. Example compression methods will be discussed in more detail below.

Still referring to FIG. 2, the gamma correction unit 230 applies gamma correction functions to the color corrected digital image data output from the CCM unit 220. The gamma correction unit 230 outputs the gamma corrected image data to a chromatic aberrations unit 240.

The chromatic aberrations unit 240 reduces or eliminates chromatic aberration in the gamma corrected digital image data and outputs the resultant digital image data for storage in the memory 308 and/or display by the display 304.

Still referring to FIG. 2, the ISP 302 also includes a controller 250 for controlling the operations of the AWB unit 210, CCM unit 220, gamma correction unit 230 and/or chromatic aberrations unit 240.

Example embodiments provide methods and apparatuses (e.g., image processing apparatuses, digital still cameras, digital imaging systems, electronic devices, etc.) capable of selectively compressing one or more pixel component values to within a valid range supported by the output system/device. For convenience, a range of [0.0 to 1.0] is used as an example valid range. In this case, the maximum value of 1.0 corresponds to 256 in case of 3×8 bit pixel.

To reduce information loss due to clipping, example embodiments compress of pixel component values outside the output gamut to within the bounds of the output gamut. As mentioned above, the output gamut refers to the gamut of the output or target device (e.g., a display device). When compressed, the colors in this predefined, given or desired region may be distorted, but the information is retained/regained, rather than lost as in the conventional art.

Methods described herein may be performed at the color correction matrix (CCM) unit 220 shown in FIG. 2, and will be described as such. However, methods according to example embodiments may be performed at other portions, components, parts or modules within an ISP as desired. Moreover, although methods and apparatuses are described herein as performing functions on vectors associated with a pixel PIX₁, it will be understood that the methods described herein may be performed on some or all pixels of an image during image processing.

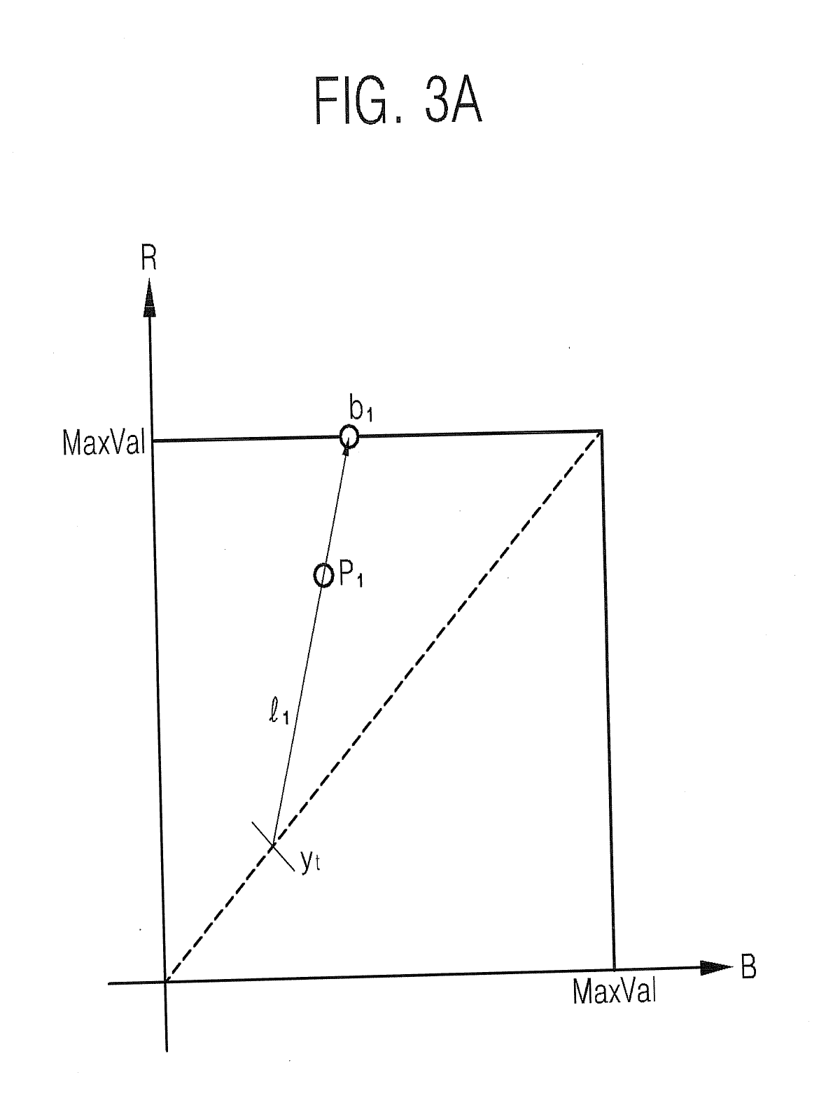

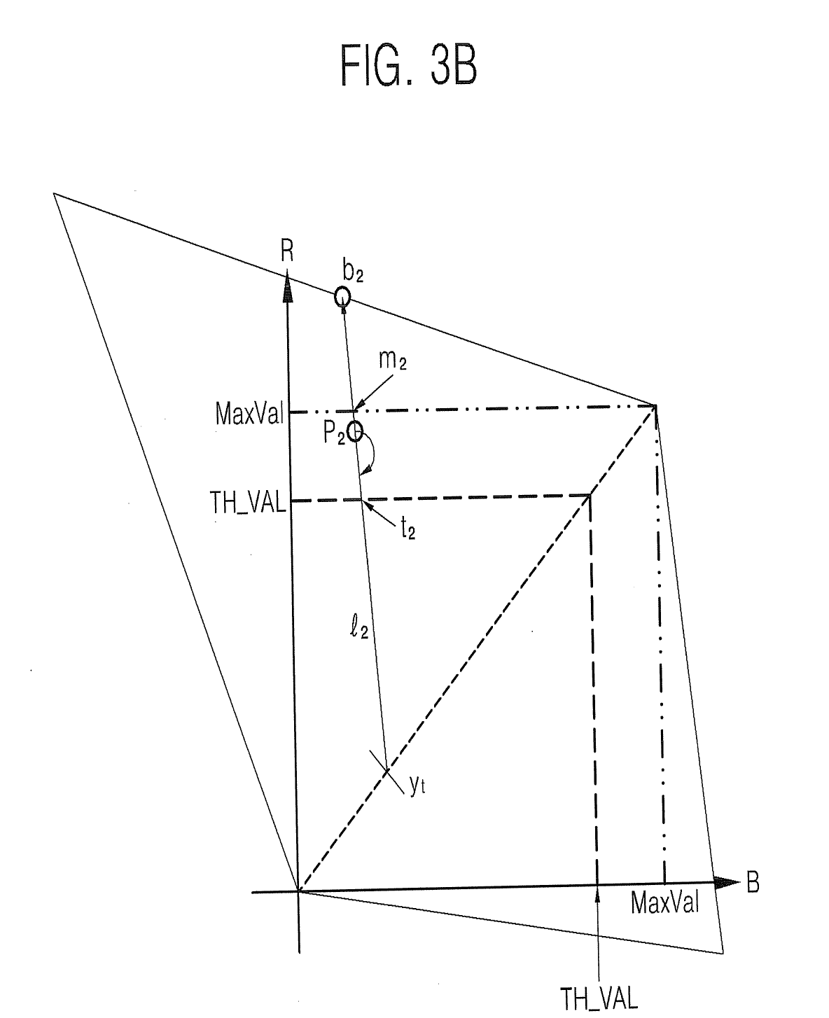

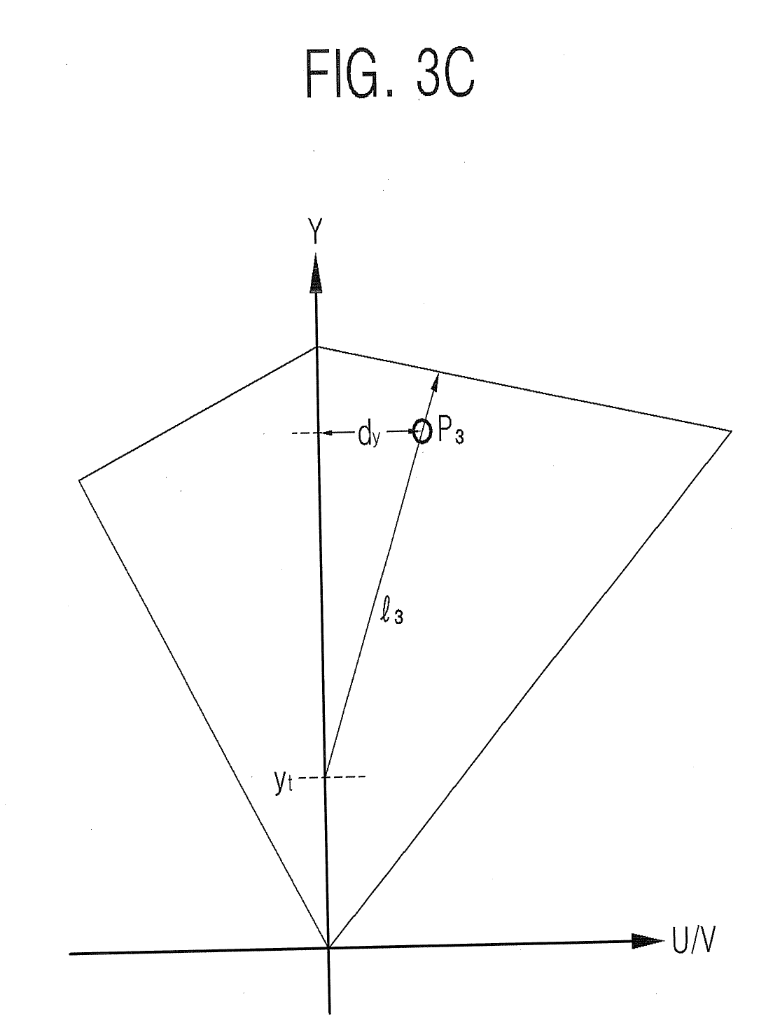

FIGS. 3A through 3C are graphs illustrating example color correction module transformation effects for an input pixel of an acquired image. A brief discussion of FIGS. 3A through 3C is provided below. These figures are then further discussed later.

FIG. 3A is a graph showing tristimulus vectors yₜ, b₁ and P₁ for a pixel input to the CCM unit 220 shown in FIG. 2, but prior to application of the color correction matrix (CCM) at the CCM unit 220. As mentioned above, each tristimulus vector is comprised of three elements or coordinates, which define a point in a given color space. The tristimulus vectors shown in FIG. 3A define points in the color space of the input device (referred to herein as the input color space).

Referring to FIG. 3A, tristimulus vector yₜ represents the gray vector or target luminance of the pixel input to the CCM unit 220 (referred to as the input pixel). Tristimulus vector P₁ is a vector representation of the color of the input pixel. As discussed herein, the tristimulus vector P₁ is referred to as an input pixel vector.

As discussed above, the mapping between an input pixel vector and a particular color of a pixel is related to the physical properties of the image sensor or other input device. In one example, the physical properties of the input device provide the input device with a particular color gamut. A particular color gamut includes a finite number of possible colors because. And, the available gamut of the input device has boundaries or limits on the available colors within the input color space. In FIG. 3A, for example, the boundary of the input gamut for the input device is denoted MaxVal.

Still referring to FIG. 3A, tristimulus vector b₁ is a saturation pixel vector. The saturation pixel vector b₁ is a tristimulus vector at which light incident on the pixel causes the particular color (or color channel) of the image sensor to respond at its maximum value. As shown in FIG. 3A, the saturation pixel vector b₁ is a vector representation of a pixel value at the boundary MaxVal of the input gamut and on the straight line l₁ connecting target luminance yₜ and input pixel vector P₁.

A property of a linear transformation is that a straight line is transformed to another straight line. According to example embodiments, the target luminance yₜ is preserved in both the input color space and the tristimulus color space for the output device (referred to as the output color space). This is seen when comparing FIG. 3A with FIG. 3B, which shows the CCM transformed graph of FIG. 3A.

In more detail with regard to FIGS. 3A and 3B, by applying a linear CCM transform, the line l₁ in FIG. 3A is transformed into straight line l₂ shown in FIG. 3B. In this example, the line l₂ is given by, for example, Equation (1) shown below.

l₂=b₂−(yₜ,yₜ,yₜ) (1)

The output gamut also has boundaries or limits within the output color space. In FIG. 3B, for example, the outer boundary of the output gamut (also referred to as the reproduction gamut) is denoted TH_VAL. As shown, in the output color space, the boundary TH_VAL of the output gamut is within the boundary MaxVal of the input gamut. As discussed herein, the threshold value TH_VAL is sometimes referred to as a gamut threshold value.

In FIG. 3B, tristimulus vector b₂ represents the CCM transform of the saturation pixel vector b₁. As discussed herein, vector b₂ may be referred to as the transformed saturation pixel vector or the output saturation pixel vector. Tristimulus vector P₂ (referred to as the output pixel vector) represents the CCM transform of the input pixel vector P₁. Tristimulus vector m₂ is a point on the line connecting the target luminance yₜ and the output pixel vector P₂ in the output color space. In one example, the maximum value of vector m₂ (denoted max(m₂)) is about 1.0.

FIG. 3C is a graph of the input pixel vector in the YUV color space. In FIG. 3C, vector P₃ represents the input pixel vector P₁ in the YUV space. As discussed herein, vector P₃ is referred to as the YUV pixel vector. Line l₃ connects the target luminance yₜ and the YUV pixel vector P₃ in the YUV color space. FIG. 3C will be further discussed below.

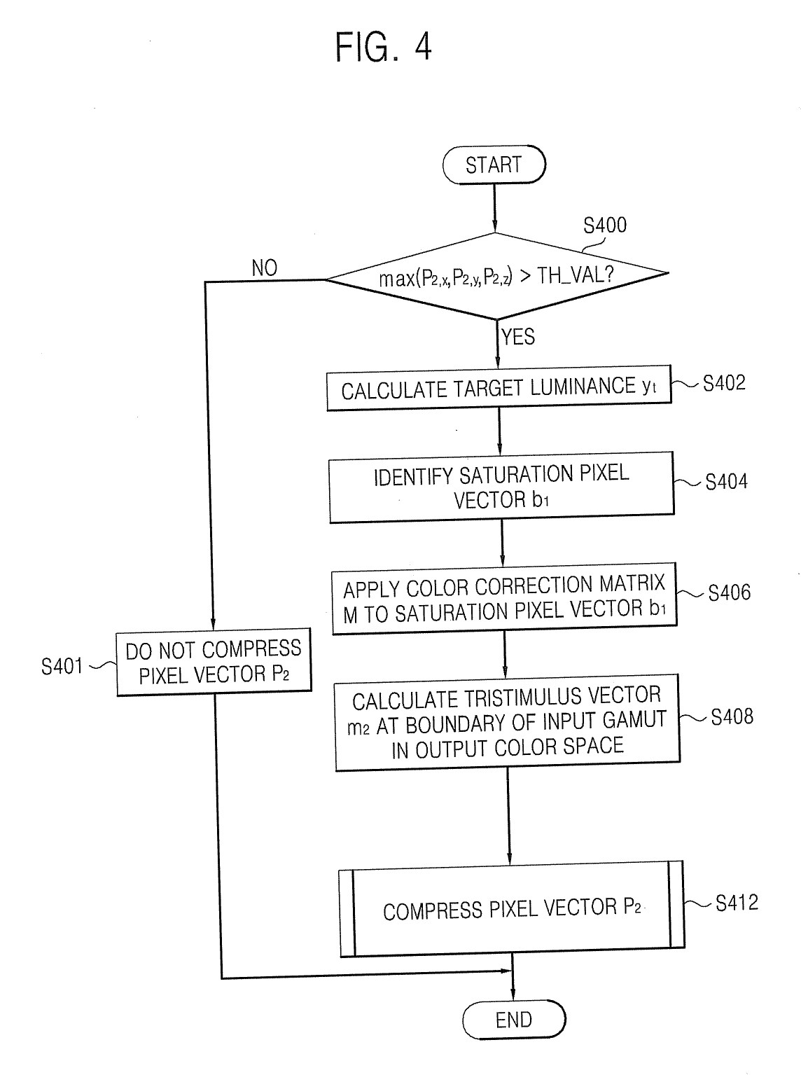

FIG. 4 is a flow chart illustrating a compression method according to an example embodiment. The method shown in FIG. 4 is discussed herein as being performed by the CCM unit 220 shown in FIG. 2. Moreover, the method shown in FIG. 4 will be discussed with regard to the graphs shown in FIGS. 3A through 3C.

Referring to FIG. 4, at S400 the CCM unit 220 determines whether to compress the output pixel vector P₂ corresponding to an input pixel PIX₁ from the AWB unit 210. In one example, the CCM unit 220 determines whether to compress the output pixel vector P₂ by comparing the maximal component of the output pixel vector P₂ with the gamut threshold value TH_VAL. The maximal component of output pixel vector P₂ (denoted max(P₂)) is the maximum value from among the vector components P_{2,x}, P_{2,y} and P_{2,z} of the output pixel vector P₂. In one example, the maximal component of output pixel vector P₂ is given by Equation (2) shown below.

max(P₂)=max(P_{2,x},P_{2,y},P_{2,z}) (2)

The boundary of the output gamut is 1.0 in the output space. The gamut threshold value TH_VAL is a parameter, which is indicative of the impact of the algorithm on input pixel information. For example, the smaller the gamut threshold value TH_VAL, the larger the impact of the compression algorithm on the input color space. The gamut threshold value TH_VAL may be set by a user as desired.

Still referring to FIG. 4, if max(P₂) is less than or equal to the gamut threshold value TH_VAL, then the CCM unit 220 determines that the output pixel vector P₂ should not be compressed at S401. Accordingly, the CCM unit 220 outputs the output pixel vector P₂.

Returning to S400, if max(P₂) is greater than the gamut threshold value TH_VAL, then at S402 the CCM unit 220 calculates the target luminance yₜ for the input pixel PIX₁ from the AWB unit 210 at S402. The target luminance yₜ is a target luminance vector for compression algorithms. And, as mentioned above, the target luminance yₜ is comprised of three components (yₜ,yₜ,yₜ).

According to at least some example embodiments, there is a tradeoff with regard to whether to preserve luminance or saturation of pixel color. The CCM unit 220 calculates the target luminance yₜ to approach this tradeoff. The target luminance yₜ is located on the gray axis of the input gamut, an example of which is shown in FIG. 3A.

According to at least some example embodiments, the CCM unit 220 calculates the target luminance yₜ in the YUV plane. Accordingly, the CCM unit 220 initially calculates YUV values for the input pixel vector P₁. FIG. 3C illustrates example YUV values for the input pixel vector P₁. These coordinates are represented by the YUV pixel vector P₃ shown in FIG. 3C.

In one example, the CCM unit 220 calculates the target luminance yₜ based on the luminance y₁ of the input pixel PIX₁, a weighting constant α assigned to preserve luminance or brightness, and the gamut threshold value TH_VAL.

In a more specific example, the CCM unit 220 calculates the target luminance yₜ according to Equation (3) shown below.

yₜ=min(αy₁,TH_{—}VAL) (3)

In Equation (3), α is a weighting constant between about 0 and about 1.0, which represents the weight given to preserve brightness or luminance. The weighting constant α may be set by a user as desired. Luminance y₁ refers to the original luminance of the input pixel PIX₁. Thus, αy₁ represents a weighted luminance metric or weighted luminance value for the input pixel PIX₁. In Equation (3), the target luminance yₜ is equal to the minimum value among αy₁ and the gamut threshold value TH_VAL.

In another example, the target luminance yₜ is calculated based on the weighting constant α, the gamut threshold value TH_VAL, and a distance d_{y}.

Referring again to FIG. 3C, the distance d_{y} is the distance between the YUV pixel vector P₃ and the Y-axis in the YUV color space.

In a more specific example, the target luminance yₜ is calculated according to Equation (4) shown below.

yₜ=min(max(y−α·d_{y},0),TH_{—}VAL) (4)

In Equation (4), α is the above-described weighting constant and the distance d_{y} is calculated according to Equation (5) shown below.

d_{y}=\sqrt{u²+ν²} (5)

In Equation (5), u and ν are the chrominance components (coordinates) of the YUV pixel vector P₃ in the YUV color space.

As shown by Equation (4), the CCM unit 220 calculates the target luminance yₜ by taking the maximum value from among (y−α·d_{y}) and 0, and then taking the minimum value from among the gamut threshold value TH_VAL and the above-mentioned maximum value.

In yet another example, yₜ is set to 0. In this example, more weight is given to preserve the saturation value of the pixel color at the expense of the saturation.

Referring back to FIG. 4, at S404 the CCM unit 220 calculates the saturation pixel vector b₁ shown in FIG. 3A. As discussed above, the saturation pixel vector b₁ is a tristimulus vector on the boundary (or edge) MaxVal of the input gamut in the input color space.

As shown in FIG. 3A, the saturation pixel vector b₁ the input pixel vector P₁ and the target luminance yₜ lie on the same line l₁. Accordingly, the saturation pixel vector b₁ may be calculated based on the input pixel vector P₁ and the target luminance yₜ. In a more specific example, the saturation pixel vector b₁ may be calculated as discussed below.

Because the saturation pixel vector b₁, the input pixel vector P₁ and the target luminance yₜ lie on the same line l₁, the saturation pixel vector b₁ is given by Equation (6) shown below.

b₁=A·(P₁−yₜ)+yₜ (6)

Moreover, max(b₁)=1.0, and thus, simple substitution obtains Equation (7) shown below.

1.0=max(b₁)=max(A·(P₁−yₜ)+yₜ)=A(max(P₁)−yₜ)+yₜ (7)

Given Equation (7), the slope A of the line l₁ can be calculated according to Equation (8) shown below because max(P₁) and yₜ are known.

$$A = \frac{1.0 - {y}_{t}}{max ( {P}_{1} ) - {y}_{t}} \qquad ( 8 )$$

Once having calculated the slope A, the saturation pixel vector b₁ for the input pixel PIX₁ can be calculated according to Equation (6) shown above.

Returning to FIG. 4, at S406, the CCM unit 220 applies a linear color correction matrix (CCM) to the saturation pixel vector b₁ to generate the output (or transformed) saturation pixel vector b₂ shown in FIG. 3B. The output saturation pixel vector b₂ is a vector representation of the input saturation pixel vector b₁ in the output color space. In one example, the CCM unit 220 calculates the output saturation pixel vector b₂ according to Equation (9) shown below.

b₂=M·b₁ (9)

In Equation (9), M is a color correction matrix for the desired output device. The color correction matrix M and the input saturation pixel vector b₁ are combined using vector multiplication.

Still referring to FIG. 4, at S408 the CCM unit 220 calculates tristimulus vector m₂.

As shown in FIG. 3B, tristimulus vector m₂ is a point in the input color space on the line l₂ connecting output pixel vector P₂ and target luminance yₜ at the boundary MaxVal. The vector m₂ lies outside of the output gamut, and in this example, the maximal component of m₂ has a value of about 1.0 in the valid range of [0.0 to 1.0].

As shown in FIG. 3B, output saturation pixel vector b₂, vector m₂ and the target luminance yₜ lie on the same line l₂ in the output color space. Accordingly, the vector m₂ can be calculated based on the output saturation pixel vector b₂ and the target luminance yₜ.

In a more specific example, vector m₂ may be given by Equation (10) shown below.

m₂=B·(b₂−yₜ)+yₜ (10)

Because the maximal component of m₂ (denoted max(m₂)) is 1.0, simple substitution provides Equation (11) shown below.

1.0=max(m₂)=max(B·(b₂−yₜ)+yₜ)=B(max(b₂)−yₜ)+yₜ (11)

Given Equation (11), the slope B of the line l₂ can be calculated according to Equation (12) shown below because max(b₂) and yₜ are known.

$$B = \frac{1.0 - {y}_{t}}{max ( {b}_{2} ) - {y}_{t}} \qquad ( 12 )$$

Once having calculated the slope B, vector m₂ can be calculated according to Equation (10) shown above.

As shown in FIG. 3B, tristimulus vector t₂ is a point in the output color space on the line l₂ connecting output pixel vector P₂ and target luminance yₜ at the boundary TH_VAL.

Although the CCM unit 220 may calculate tristimulus vector t₂, this vector need not be calculated. To perform the compression methods discussed herein, only the maximal component of vector t₂ need be known. And, this maximal value is the same as the gamut threshold value TH_VAL, which is compared with max(P₂) at S400.

Still referring to FIG. 4, at step S412, the CCM unit 220 compresses the output pixel vector P₂ such that the output saturation pixel vector b₂ is mapped to the tristimulus vector m₂, while maintaining tristimulus vector t₂. Accordingly, the segment of line l₂ connecting vector t₂ and output saturation pixel vector b₂ (t₂→b₂) is compressed to the segment of line l₂ connecting tristimulus vectors t₂ and m₂ (t₂→m₂). Said another way, value(s) of the output pixel vector P₂ is/are updated such that the output pixel vector P₂ falls within the output color gamut while preserving a hue of the pixel values.

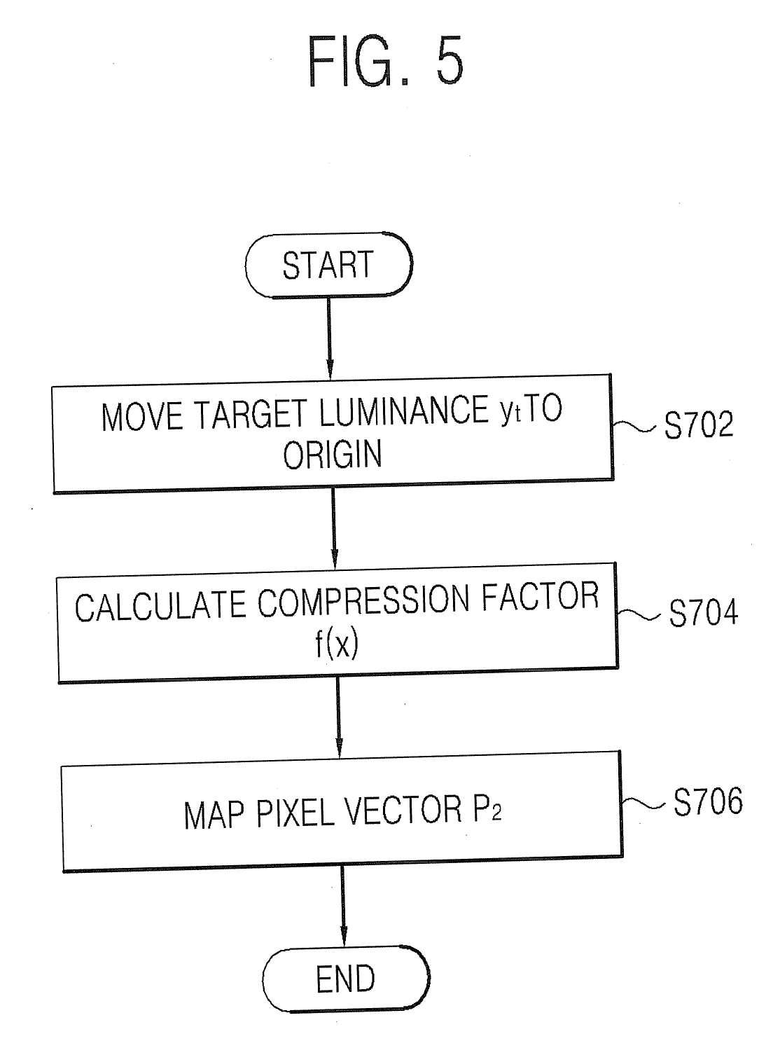

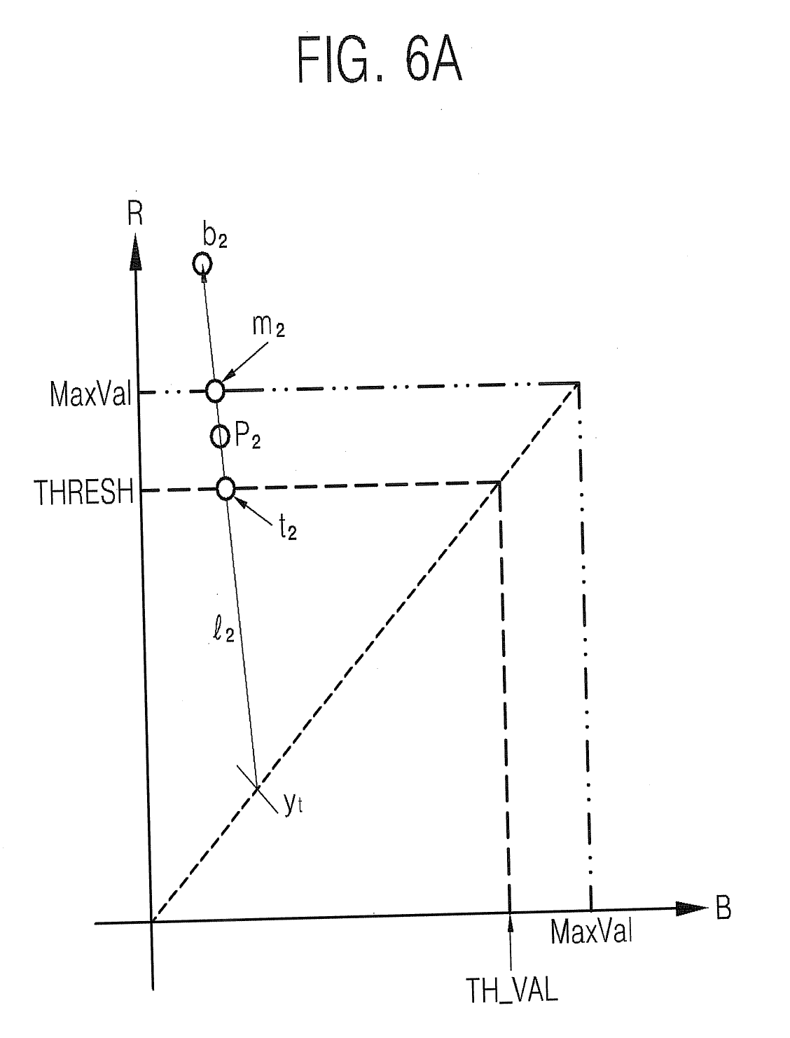

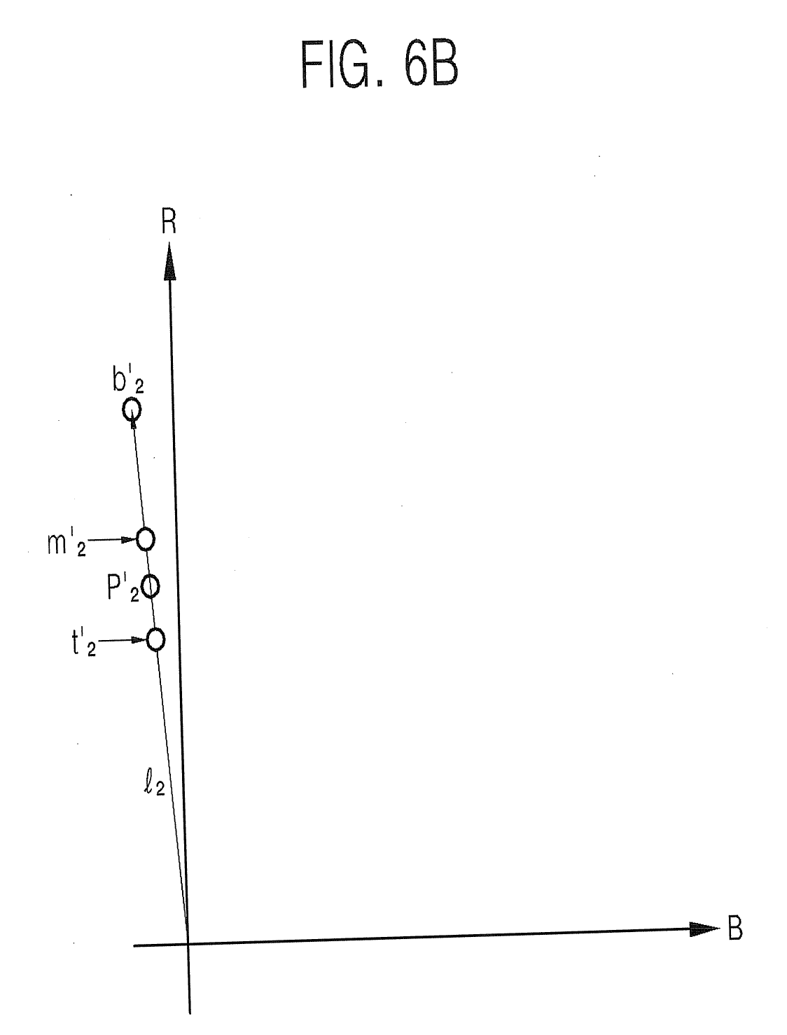

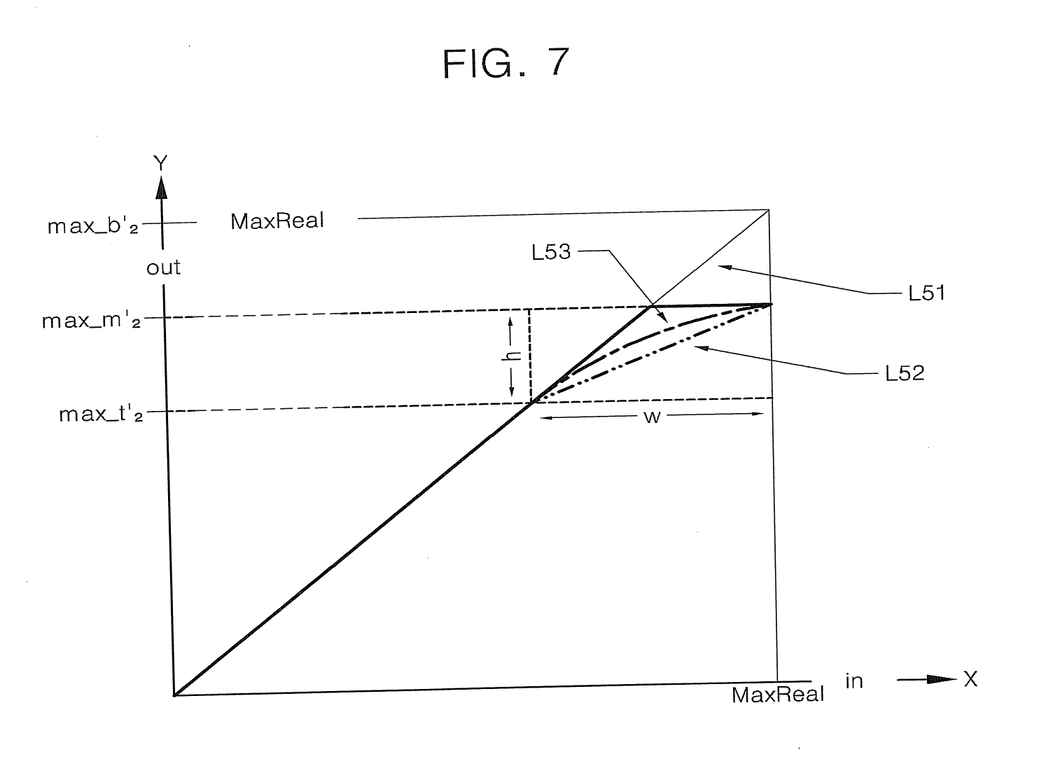

The compressing of the output pixel vector P₂ will be discussed in more detail with regard to the flow chart shown in FIG. 5 and the graphs shown in FIGS. 6A, 6B and 7.

FIG. 5 is a flow chart illustrating an example embodiment of the compression performed at S412 in FIG. 4. FIGS. 6A, 6B and 7 are graphs to help illustrate the method shown in FIG. 5.

The graph shown in FIG. 6A is substantially similar to the graph shown in FIG. 3B, and thus, will not be described in detail. FIG. 6B is a graph illustrating example positions of tristimulus vectors after moving the system such that the target luminance yₜ is located at the origin in the output color space.

Referring to FIGS. 5 through 7, at S702 the target luminance vector yₜ is moved to the origin as shown in FIG. 6B. By moving the system such that the target luminance vector yₜ is at the origin of the output color space, the tristimulus vectors on the line l₂ can be compressed by multiplying the vector components by a compression factor ƒ(x).

The compression factor ƒ(x) is calculated by the CCM unit 220 at S704.

In this example, with regard to FIG. 6B, ƒ(x) is a factor function, which continues on line l₂, is equal to 1.0 at t′₂, and satisfies b′₂×f(b′₂)=m′₂. In FIG. 6B, b′₂, m′₂, P′₂ and t′₂ are shifted values of b₂, m₂, P₂ and t₂ shown in FIG. 6A, respectively.

Referring to FIG. 7, line L52 illustrates the function g(x)=x·ƒ(x), where ƒ(x) is the factor function and x is max (P₂).

Also in FIG. 7, the maximal components of b′₂, m′₂, P′₂ and t′₂ are denoted as max_b′₂, max_m′₂, x and max_t′₂, respectively. Accordingly, the factor function ƒ(x) can be described as a function of the maximal components of the vectors b′₂, m′₂, P′₂ and t′₂. As mentioned above, the maximal component of t₂ is TH_VAL, and thus, t₂ need not be calculated.

Referring to FIG. 7, the x-axis values represent the maximal vector components as input to the CCM unit 220. Compression algorithms according to example embodiments may be applied to the x-axis values. The y-axis values in FIG. 7 represent the output of the CCM unit 220 after performing gamut compression methods described herein; that is, as mentioned above the y-axis represents x·ƒ(x), where ƒ(x) is the compression factor or factor function and x is the maximal component of the output pixel vector max (P₂).

Said another way, line L52 represents the output of the CCM unit 220 after applying a gamut compression method described herein (e.g., with regard to FIG. 4) to compress segment t₂→b₂ to segment t₂→m₂ as shown in FIG. 3B. An example calculation of line L52 in FIG. 7 will now be described.

In the example shown in FIG. 7, the input to the function ƒ(x) is x=max(P₂)−yₜ. Moreover, max_m′₂=1.0−yₜ, max_b′₂=max(b₂)−yₜ and max_t′₂=TH_VAL−yₜ. Accordingly, the line L52 representing the linear function g(x) can be described as follows:

$$g ( x ) = \{ \begin{matrix}x , & x \leq {t}_{2} - {y}_{t} \\ \frac{h}{w} ( x - ( {t}_{2} - {y}_{t} ) ) + ( {t}_{2} - {y}_{t} ) , & else .\end{matrix}$$

In this example, h and w are given by Equations (16) and (17), respectively.

h=max_{—}m′₂−(t₂−yₜ)=1.0−t₂=1.0−TH_{—}VAL (16)

w=max_{—}b′₂−(t₂−yₜ)=max(b₂)−t₂=max(b₂)−TH_{—}VAL (17)

Still referring to FIG. 7, for the sake of comparison, line L51 represents the output of the CCM unit 220 if the conventional clipping method is applied.

Line L53 in FIG. 7 represents an output that assures the continuity of both the function and its derivative as much as possible, and may be created by any monotonous convex function such as square root. Line L53 shown in FIG. 7 is an example output representing a member of a family of factor functions (discussed in more detail below) for given values of w and h.

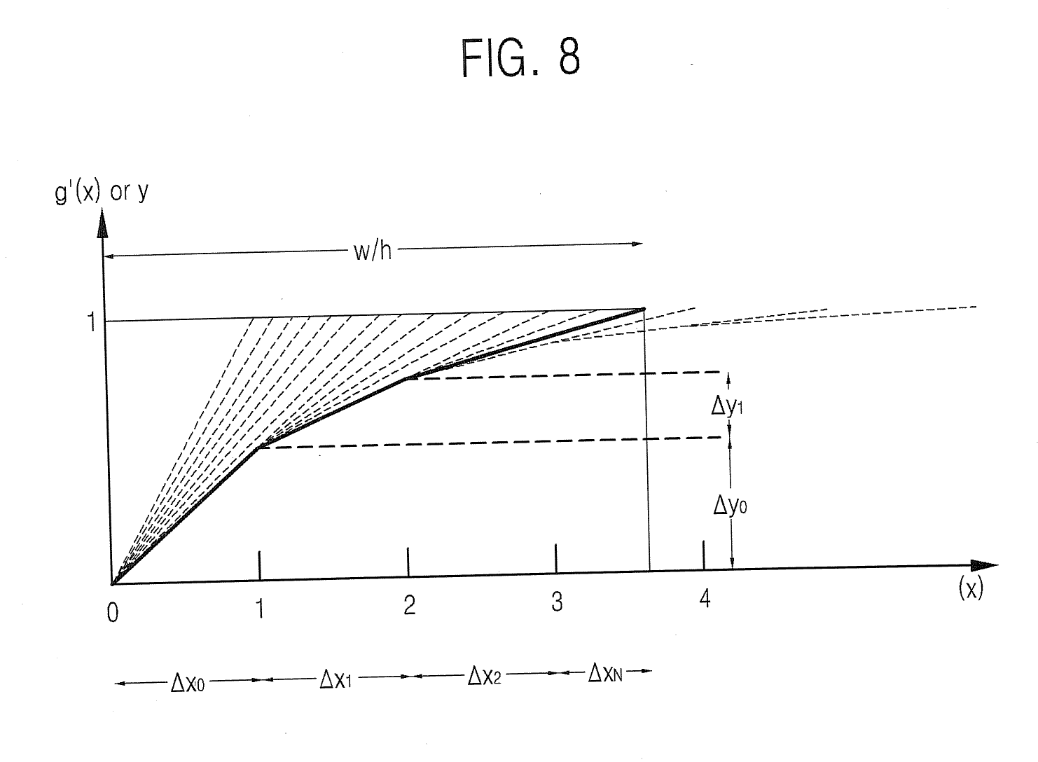

FIG. 8 is a graph for illustrating a method of calculating a family of compression curves for compressing an output pixel vector according to an example embodiment. The method described with regard to FIG. 8 will also be described as being performed at the CCM unit 220.

According to at least this example embodiment, the CCM unit 220 generates a family of factor functions for compressing the output pixel vector x into an output signal y with a lower dynamic range, depending on the required compression ratio given by the particular w and h values shown in FIG. 8. The CCM unit 220 may compress the output pixel vector x according to at least one factor function from among the plurality of factor functions. As shown in FIG. 8, the factor functions in the family are similar to each other, and gradually decrease as the value of x increases.

Referring to FIG. 8, the dotted lines illustrate possible factor functions for different input ranges w and h. The solid piece-wise linear function is an example of one family member (N=1) for given values of w and h.

According to at least one example embodiment, a factor function, such as the factor function corresponding to line L53, is generated by decreasing the slope by a factor of 2 at each sample point and distributing the y-axis sample points according to the logarithmic distribution given by Equations (18) and (19) shown below.

y₀=0 (18)

yᵢ=1−2⁻ⁱ (19)

In Equation (19), yᵢ is given by Equation (20) shown below.

yᵢ=yᵢ₋₁+Δyᵢ₋₁ (20)

And, Δyᵢ is given by Equation (21) shown below.

Δyᵢ=2⁻⁽ⁱ⁺¹⁾ (21)

Further, the change Δxᵢ in the x-value of the sample points is 1 as shown below in Equation (22).

$$\frac{Δ {y}_{i}}{Δ {x}_{i}} = {2}^{- i - 1} ⇒ Δ {x}_{i} = 1 \qquad ( 22 )$$

In the example shown in FIG. 8, the sample points are (0,0), (1,1-2⁻¹), (2,1-2⁻²), . . . , (x_{N},1-2^{-N}), where N is the maximum value of L

Because all slopes in this example are powers of 2, hardware computation may be more efficient without using a divider.

Still referring to FIG. 8, depending on whether

$$\frac{w}{h}$$

is an integer, the N^{th} interval Δx_{N} is less than or equal to 1 (e.g., N=3 in FIG. 8). For the entire interval

$${x}_{N - 1} … \frac{w}{h} ,$$

the slope

$$\frac{Δ {y}_{N - 2}}{\frac{w}{h} - Δ {x}_{N - 1}}$$

is calculated using a divider. However, the average number of divisions required by this algorithm is still less than the number of compressed signals because not all signals fall into the interval

$${x}_{N - 1} … \frac{w}{h} .$$

According to at least some example embodiments, the sample points may be distributed equally or in logarithmic inverse order along the y-axis. However, the logarithmic distribution may better fit gamut mapping applications.

The compression function g′(x) for specific ratio

$$\frac{w}{h}$$

may be given by Equation (23) shown below.

$${g}^{′} ( x ) = \{ \begin{matrix}( x - {x}_{i} ) / {2}^{i + 1} + ( 1 - {2}^{- i} ) , & if i < N - 1 \\ ( x - {x}_{N - 1} ) \frac{Δ {y}_{N - 2}}{\frac{w}{h} - {x}_{N - 1}} + ( 1 - {2}^{- ( N - 1 )} ) , & if i \geq N - 1\end{matrix} \qquad ( 23 )$$

In Equation (23), I is determined as an integer part of x: i=└x┘.

The functions shown in FIG. 8 and given by Equation (23) are limited to between 0 and 1. But, deriving g(x) from g′(x) to any range is straight forward by linear transformations of function input x and output g′(x).

Returning to FIG. 7, after calculating the factor function ƒ(x) at S704, the output pixel vector P₂ is mapped to its compressed value P_{MAP} at S706. In a more specific example, the compressed output pixel vector P_{MAP} is calculated according to Equation (18) shown below.

P_{MAP}=f(P′₂)×P′₂+yₜ Equation (18)

According to Equation (18), the compressed output pixel vector P_{MAP} is calculated based on the target luminance yₜ, the shifted output pixel vector P′₂ and a compression factor f (P′₂), which is calculated as a function of the shifted output pixel vector P′₂. In this example, the compressed output pixel vector determined according to the system with a target luminance yₜ located at the origin (e.g., as shown in FIG. 6B) is moved such that the target luminance is relocated to its original position (yₜ, yₜ, yₜ), shown in FIG. 6A, for example.

Although example embodiments of compression algorithms are described herein with regard to color correction and/or gamut mapping, it will be understood that compression algorithms described herein may be implemented in connection with other applications. For example, methods and apparatuses described herein may be applicable to any signal compression application where a family of compression curves is needed to be applied to signals with minimum amount of calculations.

The foregoing description of example embodiments has been provided for purposes of illustration and description. It is not intended to be exhaustive or to limit the disclosure. Individual elements or features of a particular example embodiment are generally not limited to that particular example embodiment, but where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for out-of-gamut color correction of an image for display by an output device having a corresponding output color gamut, the image including a plurality of pixels, and each of the plurality of pixels having a corresponding pixel vector representing a color, the method comprising:
color correcting, by an image signal processor, the image by compressing pixel vectors having a maximal component located outside of the output color gamut to within the output color gamut while retaining a hue of the image.

2. The method of claim 1, further comprising:
comparing at least a first maximal component of at least a first of the pixel vectors with a gamut threshold value; and
compressing the first pixel vector if the first maximal component exceeds the gamut threshold value.

3. The method of claim 2, wherein the first pixel vector is not compressed if the first maximal component does not exceed the gamut threshold value.

4. The method of claim 2, wherein the first pixel vector corresponds to a first pixel among the plurality of pixels, the method further comprising:
calculating a target luminance for the first pixel, the target luminance being calculated based on a weighted luminance metric for the first pixel and the gamut threshold value; and wherein
the first pixel vector is compressed at least partially based on the calculated target luminance.

5. The method of claim 4, wherein the target luminance is equal to a minimum value from among the weighted luminance metric and the gamut threshold value.

6. The method of claim 4, further comprising:
calculating an input saturation pixel vector associated with the first pixel, at least one component of the input saturation pixel vector representing a maximum value for a color in an input color space, and the input color space being a color space associated with an image acquisition device having acquired the image;
calculating an output saturation pixel vector by applying a color correction matrix to the input saturation pixel vector; and wherein
the first pixel vector is compressed based on the target luminance and the output saturation pixel vector.

7. The method of claim 2, wherein the first pixel vector corresponds to a first pixel among the plurality of pixels, the method further comprising:
calculating a target luminance for the first pixel, the target luminance being calculated based on a weighting constant, a luminance of the first pixel and the gamut threshold value; and wherein
the first pixel vector is compressed based on the calculated target luminance.

8. The method of claim 7, further comprising:
calculating an input saturation pixel vector in the input color space, at least one component of the input saturation pixel vector representing a maximum value for a color in an input color space, and the input color space being a color space associated with an image acquisition device having acquired the image;
calculating an output saturation pixel vector by applying a color correction matrix to the input saturation pixel vector; and wherein
the first pixel vector is compressed based on the target luminance and the output saturation pixel vector.

9. The method of claim 2, wherein the first pixel vector corresponds to a first pixel among the plurality of pixels, the method further comprising:
setting a target luminance for the first pixel equal to zero; and wherein
the first pixel vector is compressed based on the set target luminance.

10. The method of claim 9, further comprising:
calculating an input saturation pixel vector in an input color space, at least one component of the input saturation pixel vector representing a maximum value for a color in the input color space, and the input color space being a color space associated with an image acquisition device having acquired the image;
calculating an output saturation pixel vector in the output color space by applying a color correction matrix to the input saturation pixel vector; and wherein
the first pixel vector is compressed based on the target luminance and the output saturation pixel vector.

11. The method of claim 1, wherein the pixel vectors are compressed by applying a compression factor to the pixel vectors.

12. The method of claim 2, wherein the first pixel vector corresponds to a first pixel among the plurality of pixels, and the compressing comprises:
shifting tristimulus vectors associated with the first pixel such that a target luminance for the first pixel is located at an origin of an output color space, the tristimulus vectors including at least an input pixel vector representing a color of the first pixel;
calculating a compression factor based on the shifted tristimulus vectors; and
compressing the pixel vectors based on the compression factor, the shifted input pixel vector and the target luminance.

13. The method of claim 1, further comprising:
generating the pixel vectors by applying linear color correction to a plurality of input pixel vectors, each of the plurality of input pixel vectors representing a color of a corresponding one of the plurality of pixels.

14. The method of claim 1, wherein the input pixel vectors are white balanced prior to the color correcting.

15. The method of claim 1, further comprising:
displaying the color corrected image via the output device.

16. The method of claim 1, further comprising:
storing the color corrected image in a memory.

17. The method of claim 1, wherein the pixel vectors are compressed by applying at least one factor function from among a family of factor functions to the pixel vectors, the family of factor functions including a plurality of factor functions, which gradually decrease relative to one another as input values increase.

18. An electronic imaging system configured to perform out-of-gamut color correction of an image for display by an output device having a corresponding output color gamut, the image including a plurality of pixels, and each of the plurality of pixels having a corresponding pixel vector representing a color, the electronic imaging system comprising:
an image signal processor configured to color correct the image for display by the output device by compressing pixel vectors having a maximal component located outside of the output color gamut to within the output color gamut while retaining a hue of the image.

19. The electronic imaging system of claim 18, further comprising:
an image sensor configured to acquire the image by converting incident light into a digital output code.

20. The electronic imaging system of claim 18, further comprising at least one of:
a display device configured to display the color corrected image; and
a memory configured to store the color corrected image.
